(19) United States
(12) Patent Application Publication
(10) Pub. No.: US 2026/0107217 A1
(43) Pub. Date: Apr. 16, 2026

(54) HANDLING SYSTEM INFORMATION IN A WIRELESS NETWORK USING A NETWORK-RECONFIGURABLE SOFTWARE FUNCTION IN A WIRELESS DEVICE

(71) Applicant: Telefonaktiebolaget LM Ericsson (publ), Stockholm (SE)

(72) Inventors: Gunnar MILDH, SOLLENTUNA (SE); Patrik RUGELAND, BROMMA (SE); Mehdi ABAD, AACHEN (DE); Massimo CONDOLUCI, SOLNA (SE); Icaro Leonardo DA SILVA, SOLNA (SE); Jale SADREDDINI, OTTAWA (CA)

(73) Assignee: Telefonaktiebolaget LM Ericsson (publ), Stockholm (SE)

(21) Appl. No.: 19/115,741

(22) PCT Filed: Sep. 27, 2022
(86) PCT No.: PCT/SE2022/050857

§ 371 Date: Mar. 26, 2025

(51) Int. Cl. H04W 48/10

(52) U.S. Cl. CPC H04W 48/10

(57) ABSTRACT

Methods for flexible system information delivery and interpretation include an example method performed by a wireless device, where the example method comprises receiving system information broadcasted by one or more network nodes in a wireless network and interpreting a first portion of the system information using a network-reconfigurable software function in the wireless device. The method further comprises performing one or more communication-related actions, based on this interpreting. This first portion of system information may comprise one or more information elements in a system information block, SIB, and the method may further comprise interpreting one or more other portions of the received system information using non-network-reconfigurable functionality in the wireless device.

### STATEMENT REGARDING GOVERNMENT FUNDING

The project leading to this application has received funding from the European Union's Horizon 2020 research and innovation program under grant agreement No 101015956.

### TECHNICAL FIELD

The present disclosure is directed to wireless communication networks and is more particularly directed to the handling of system information in such networks.

### BACKGROUND

Current cellular systems such as those standardized in specifications developed by members of the 3rd-Generation Partnership Project (3GPP) typically include a cell broadcast channel used to deliver critical information about the system. This information may be referred to as “system information,” as it is in 3GPP documentation. The wireless devices (referred to as “user equipments” or “UEs” in 3GPP terminology) receive and process the information sent by the network on this broadcast channel, via the radio base station, to determine, for example, things like:
the Public Land Mobile Network identifier (PLMN ID) of the operator offering services on this cell or carrier.
information about the configuration of other control channels in the cell, such as the common physical downlink control channel (PDCCH) configuration and uplink random access channel (RACH) configuration.
information about cell barring, or other access control restrictions (e.g., due to high cell load).
information on cell re-selection criteria, for both intra-and inter-frequency re-selection as well as inter-radio-access-technology (inter-RAT) re-selection.
information on presence and scheduling information for other system information blocks.
information on supported services (e.g., emergency call support).

The cell broadcast channel is broadcasted out to the whole cell coverage area and can therefore be decoded by any UE supporting the radio access technology (RAT) and frequency band used in the cell. The terms “broadcast” and “broadcasted,” as used herein, refer to the transmitting of signals for reception by wireless devices, but without regard to any particular wireless connection and thus without regard to whether any particular wireless device actually receives it. “Broadcasted” signals are thus distinct from “dedicated” transmissions, which are targeted at a particular wireless device or group of wireless devices. Advantages of the broadcast channel are that:
it can be read by UEs prior to them registering or connecting to the cellular network (which is used for instance at initial PLMN, RAT, frequency cell search),
it can also be read by UEs which are currently in a low power state (sleep state) where their exact location is not known by the network, and
it can be an efficient way of delivering data or control information that is relevant for all or multiple UEs in the same cell, as opposed to sending the information in multiple dedicated messages. One example of this is the delivery of frame numbers, which are used as a common time reference for different control channels (e.g., RACH slots).

The cell broadcast channel is typically designed to be backwards compatible, meaning that if new information elements are added to the broadcast channel this does not impact how the prior elements are delivered. This means that legacy UEs not supporting the new elements can still decode the other system information from the broadcast channel, while simply ignoring the new elements.

Broadcasted system information as described above is distinct from configuration information delivered by dedicated messages. For UEs that are connected to the network, i.e., that are in an active state and/or have ongoing uplink or downlink transmissions and/or are known to reside in a certain cell by the network, it is possible to deliver control or configuration information to the UE using dedicated (UE-specific) control channels and messages. Dedicated delivery of control messages is typically more efficient for delivering information to specific UEs, since it is possible to use link adaptation and possibly beamforming, tailored to the transmission of the control message for a specific UE. Dedicated messages also need not be backwards compatible to the same extent as broadcasted system information, since the network can obtain knowledge of what specific features the UE supports (e.g., by obtaining UE radio access capabilities) and thus target the message to a format supported by the UE. Typically, however, the introduction of new messages is usually built on backwards compatible messages, i.e., so that a UE already in the market can acquire all needed information using only “old” message formats whereas newer UEs can acquire additional information using the “new” message formats.

The broadcast channel and system information coding and delivery for cellular technologies such as 4G LTE or 5G NR are standardized in 3GPP. For instance, the coding of the system information blocks (SIBs) is specified in 3GPP TS 36.331 for LTE and 3GPP TS 38.331 for NR, with updated revisions of these standards being released from time to time to introduce new features.

In the first standard release of each cellular technology, the basic principles for the broadcast channel and system information are defined. This includes how the UE should detect and synchronize to the downlink carrier signal, how it should find the time/frequency slot where the primary system information (SI) is transmitted, i.e., in a system information block (SIB) called the Master Information Block, or MIB, how it should decode the MIB, and how it should use the information in the MIB to receive and decode other SIBs (e.g., SIB1, SIB2, . . . ).

These specifications are future proof in the sense that it is possible to add new information elements to system information broadcasted by the cell in later releases of the specifications. This has been happening in each generation of mobile systems such as 3G, 4G and 5G. These new elements can be read (interpreted, decoded) by new UEs supporting those releases. Legacy UEs on the market or in the field at the time new information elements are introduced simply ignore any additional elements that are added to later releases than the latest release the legacy UE supports.

New information elements can be added to the standards in multiple ways. First, they can be introduced as non-critical extensions, which UEs of earlier releases will ignore. This can be done in multiple ways, e.g., UEs of Rel-X might ignore all information in a given message after bit Y. Alternatively, it is possible to define an extension marker with a length field indicating how many bits an element or a set of elements occupies in the message, making it possible for legacy UEs who understand the coding of the extension marker but do not understand or use the new information elements to ignore these information elements. A second way to introduce new elements is by defining new SIBs that are just ignored by legacy UEs. A third way is to specify a new broadcast channel or alternative way of delivering SI. In this case, new UEs will search for the new broadcast channel, either for use in addition to the legacy broadcast channel or as an alternative to the legacy broadcast channel. Normally, this solution is avoided, since it will split users across multiple broadcast channels, which could result in more control signaling overhead.

Common to all the solutions above is that SI is added by updating the standard release, meaning it needs to be done by the standardization organization or group responsible for the standard. Thus, adding new information to system broadcast is a cumbersome process, typically requiring significant time for standardization, implementation, testing, and deployment. This means that it can take years from a new information element being identified as useful until there are wireless devices out in the market able to use this new information element.

Despite the success of the mobile telecom industry, driven by a global standardization forum like 3GPP, the innovation cycle remains somewhat slower than elsewhere in the Information Technology (IT) industry. Recent initiatives in the area of the so-called Software Defined Network (SDN) opened up new ideas introduced in the 5G Core Network (5GC), such as separation between Control Plane (CP) and User Plane (UP) functions, and the opening of application programming interfaces (APIs) that could be used by a third party, so that control functions could be programmed and automated. In addition, virtualization and cloud technologies have been used to program these API(s) on the network side.

In the Radio Access Networks (RAN) domain, initiatives in the area of RAN programmability have also started to pop up in the past few years. However, these initiatives have been limited to initiatives to open API(s) on the network side, so that a third-party vendor, i.e., a party different from the vendor manufacturing the network equipment with the open APIs, could use these APIs to program algorithms for controlling UE behavior.

The benefits of such initiatives are limited to only those terminals or UEs that support a given version of the 3GPP specifications. In other words, while a programmer benefiting from these possibly opened APIs could in theory design a new scheduling algorithm, he or she cannot influence the type of information a terminal reports or some other specific behavior the program intends the UE to perform upon receiving a given command. These UE functionalities would still have to be introduced via standardization.

Further, even if UE behavior is updated in the standards, not all UE on the markets will support the new standard, meaning network vendors must support legacy behavior for a long period. This makes standardization cautious, and also makes network design more and more complex as the given generation of mobile network evolves.

In view of these limitations, improved techniques for defining and deploying new UE functionalities are needed.

### SUMMARY

An important hurdle to the deployment of new UE functionality is the introduction of new information elements (IEs) in broadcasted system information in the cellular network. Currently, introducing new IEs through the standardization process is a lengthy process. Furthermore, UEs already on the market or in the field are unable to benefit from newly introduced IEs.

The techniques described herein provide a new mechanism for delivering, decoding, and acting on system information (SI) in the wireless device. The methods described herein make it possible in the implementation of the cellular system to quickly add new features to the system (network and UE) relying on broadcasted SI. Various embodiments of these methods are based on the UE obtaining a software function, e.g., from the network, for receiving (i.e., reading and decoding) broadcasted SI. The software function can be dynamically updated in the UE, under network control, and can therefore be customized for individual networks or network operators, as well as being customized to different network slices, use cases, regions or cells. The new features can therefore be operator and/or use-case specific. This software function is therefore referred to herein as a “network-reconfigurable software function,” to distinguish this software function from the factory-installed software and firmware on the UE, as well as from updates to this factory-installed software and firmware provided by the supplier of the UE.

Example embodiments of the techniques described herein include methods implemented by a wireless device, e.g., a 3GPP UE, for receiving and interpreting system information using this network-reconfigurable software function. An example method comprises receiving system information broadcasted by one or more network nodes in the wireless network and interpreting a first portion of the system information using a network-reconfigurable software function in the wireless device. The method further comprises performing one or more communication-related actions, based on this interpreting of the first portion of the system information. This first portion of system information may comprise one or more information elements in a SIB, and the method may further comprise interpreting one or more other portions of the received system information using non-network-reconfigurable functionality in the wireless device.

Corresponding methods on the network side include methods for delivering system information to be interpreted using a network-reconfigurable software function. An example method, implemented by one or more network nodes in a wireless network, comprises the step of broadcasting system information, the system information including a first portion for interpretation by a network-reconfigurable software function executed by one or more receiving wireless devices. The system information may further comprise one or more other portions for interpretation by the one or more receiving wireless devices using non-network-reconfigurable functionality.

Corresponding apparatuses are also described in detail below. An example wireless device, for instance, is adapted to carry out the method summarized above. This wireless device may comprise communication interface circuitry, as well as processing circuitry operatively associated with the communication interface circuitry. The processing circuitry may be configured to: receive system information broadcasted by one or more network nodes in the wireless network; interpret a first portion of the system information using a network-reconfigurable software function in the wireless device; and perform one or more communication-related actions, based on this interpreting of the first portion of the system information.

Similarly, network nodes adapted to carry out the network-node-related method summarized above are also described below. An example network node comprises communications interface circuitry configured for communicating with one or more other network nodes and with one or more wireless devices, as well as processing circuitry operatively associated with the communications interface circuitry. The network node's processing circuitry may be configured to broadcast system information, where the system information includes a first portion for interpretation by a network-reconfigurable software function executed by one or more receiving wireless devices.

Using the techniques and apparatuses described herein, it is possible to dynamically (or on a need basis) add new features that rely on system information broadcast, where these new features can also be applied by wireless devices already in the market or operating in the field, without requiring that a software or firmware update be provided to the various wireless devices by their respective UE or wireless device vendors. The features can be specific to a particular operator, market, or network vendor.

Other advantages of the presently disclosed techniques and their corresponding apparatuses and systems will be apparent upon reading the detailed description that follows and examining the attached figures.

### BRIEF DESCRIPTION OF THE FIGURES

FIG. 1 illustrates an example network scenario for use of the techniques described herein.

FIG. 2 is a signaling flow diagram illustrating the obtaining and use of a network-reconfigurable software function to read and apply system information, according to some embodiments.

FIG. 3 is a signaling flow diagram showing the use of UE-specified application program interfaces (APIs) to generate a software function for the UE or wireless device, according to some embodiments.

FIG. 4 is a process flow diagram illustrating an example method carried out by a wireless device, in some embodiments.

FIG. 5 is a process flow diagram showing a method carried out by one or more network nodes.

FIG. 6 illustrates a wireless communication system in which the presently disclosed techniques may be employed.

FIG. 7 is a block diagram of an example wireless device, or UE.

FIG. 8 is a block diagram of an example network node.

FIG. 9 illustrates an example host, according to some embodiments.

FIG. 10 shows an example of a virtualization environment, in which certain aspects of the techniques described herein might be implemented.

### DETAILED DESCRIPTION

Some of the embodiments contemplated herein will now be described more fully with reference to the accompanying drawings. Embodiments are provided by way of example to convey the scope of the subject matter to those skilled in the art.

In the detailed description that follows, 3GPP terminology, such as “UE,” is used to describe various embodiments of the presently disclosed invention. This is for convenience, and it should be understood that the techniques are more generally applicable to devices and systems having the same or similar functionalities as their 3GPP counterparts, regardless of the terminology. Thus, for example, where the detailed description below uses the term “UE”, this term should be understood to be interchangeable with the terms “wireless device,” “mobile terminal,” and the like, for the purposes of understanding the scope of the techniques, systems, and devices described herein.

As discussed above, it can take years to add new information elements (IEs) to the broadcasted system information (SI) in a cellular network, which in turn means that it takes a long time to introduce new wireless network features and services that rely on the broadcast of SI. Additionally, those new features whose information is broadcasted via SI will typically only be supported for new UEs, i.e., those UEs implementing such a feature of a particular release before the UEs leave the factory, and will be ignored by legacy devices. In theory, it is possible to update the software/firmware of legacy UEs to later add support for newly standardized features or functionality, but it is not possible today to mandate that all devices should be updated. Thus, even if some devices are updated in this manner, the system still needs to assume that there will be devices out on the market that do not support the feature.

Another challenge is that it is not possible to customize features for specific networks or for a specific operator, since there are no practical means for devices to apply different software or firmware for different network operators. This leads to that only features that are applicable to all operators in a large number of markets are implemented by the UE or wireless device vendors. This also means that it is not possible to customize the software or firmware for specific network slices, or network regions or cells, or for different network vendors.

In comparison, it is possible in typical web-based systems to quickly introduce and test new features in end-user clients, since the application or web-browsers running in the clients are fully software-based and can quickly be updated by the company developing the functionality. Typically, it is possible to update the client software even on quite old computers or other devices, and it is also possible to mandate that all clients are updated to a certain version of the software before connecting to the servers. In many cases, parts of the software (e.g., used for local interaction) are downloaded when the device connects to a server. This makes it possible to customize the client behavior for different sites. For instance, this is commonly used when a user is connected to a webserver using a web-browser supporting JavaScript.

In summary, the problem that is addressed by the techniques described herein is that currently it is not possible for the network (or network operator) to introduce a new feature to be applied for a UE or wireless device that is out in the market, for the several reasons given above, when the new feature requires the UE or wireless device to obtain some system information for configuring the new feature and/or the UE or wireless device is required to perform actions according to that configuration.

The various techniques described herein are based on three parts:
Mechanisms for the UE or wireless device to obtain, from the network (directly, or from a source indicated by the network), a software program, or “function” (or one or more configurations or rules that accomplish the same result as a program or function). The software program/function is associated with a specific network or operator and can be valid/used in a specific area in the network or when the user accesses a specific network slice.
A mechanism for the UE or wireless device to obtain broadcasted system information that is decoded by the software program/function. The system information bit(s) may be specific to a specific software program and can be ignored by UEs not supporting that particular program.
A mechanism for the software program to trigger actions in the UEs based on the broadcasted system information (examples of actions triggered by the system information are provided in the detailed description).

With the mechanisms briefly described above, it is possible to dynamically (or on a need basis) add new features relying on system information broadcast, which can also be applied by existing (i.e., out in the market and operating in live networks) wireless devices without requiring that a software or firmware update is provided by all UE vendors. The features can be specific to a specific operator, market or network vendor.

A key part of several of the embodiments described herein is a mechanism for a wireless device connected to a wireless network (e.g., a Next Generation Radio Access Network and/or a 6G radio access network) to obtain information broadcasted by the wireless network that is specific for a software function associated with the wireless network (or a sub-area of the wireless network, or a slice of the wireless network, or a specific network vendor associated with the wireless network), where the information broadcasted by the wireless network is interpreted (read, decoded) based on the software function and used to change the device behavior with respect to communicating with the wireless network or communicating with other entities connected to the wireless device, or information provided to the end user of the wireless devices. Note that the term “UE” may be used in this document to describe various aspects of the presently disclosed techniques. While this is 3GPP terminology, it should be understood for present purposes as being interchangeable with the more general term “wireless device,” as the presently disclosed techniques are not limited to those networks standardized by 3GPP.

Also of note is that the “software programs” or “software functions” described herein are distinct from the device software or firmware currently provided by device vendors, which may or may not update the behavior of the device or UE with respect to how the device or UE communicates with the network, in that the software programs/functions described herein are associated with a specific wireless network, can be changed dynamically based on the information provided by the network, and specifically support features associated with broadcast information that is associated with the software function/program. The term “network-reconfigurable software function” should be understood as referring specifically to the “software programs” or “software functions” described herein and should be understood to exclude software and firmware installed by the manufacturer of the UE or wireless device or updates to this factory-installed software and firmware. These network-reconfigurable software functions (i.e., the “software programs” and “software functions” described herein, are managed and provided to devices by the wireless network, typically with no involvement of the device vendor. It will be appreciated that the term “network-reconfigurable software function” also excludes applications (or “apps”) and/or scripts downloaded to the wireless device from application servers outside the control of the wireless network operators, at least in the sense that these application-level programs are unable to influence how the wireless device reads or interprets system information.

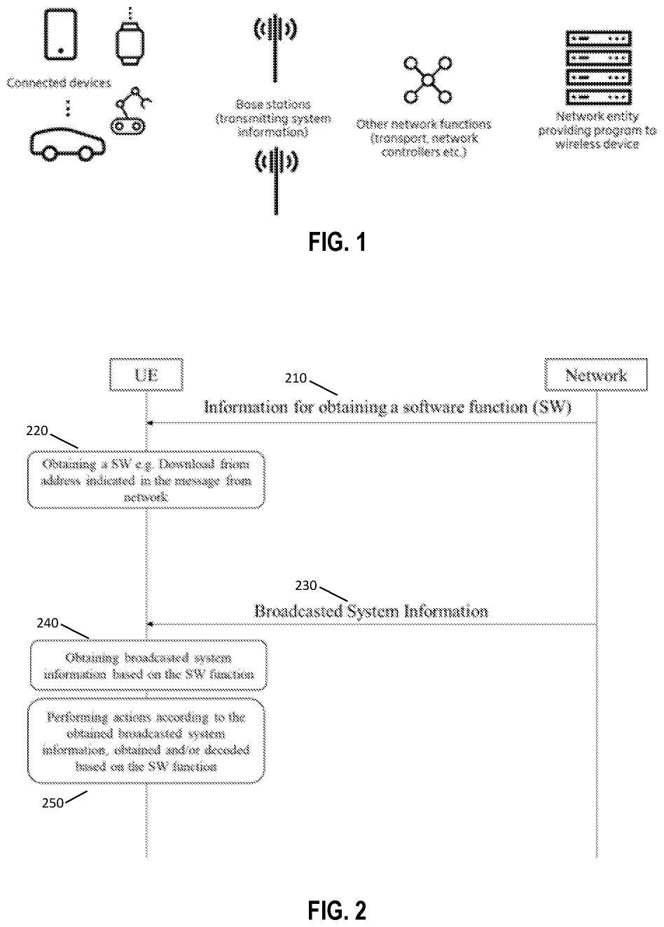

FIG. 1 shows an example network scenario involving connected devices with wireless device capabilities, i.e., wireless devices able to connect to a wireless network with base stations and other network functions. In various embodiments of the techniques and systems described herein there is a network entity, e.g., in a network node such as a base station or other network component, that is able to program the wireless device parts, e.g., the cellular modem behavior/functionality, of the connected devices (in the rest of the text called wireless devices or UEs for simplicity). Programming the wireless devices may include providing the device with updated software that is specific for the network the wireless device is connected to. In alternative embodiments the programming entity can be located in the mobile network, or outside the mobile network and/or outside the mobile network operator premises. For simplicity, sometimes the text refers to the Network as a generic entity with which the wireless device communicates and from which the wireless device obtains information.

In various embodiments, base stations in the wireless network transmit broadcast information, also known as system information, which can be received by the wireless devices and be used to alter the wireless device behavior.

As an example, the changed device behavior could include changing the condition for when and how the wireless device should connect or signal with the network (e.g., which cell the wireless device should connect to, which frequency/time resources it should use, which format messages should have, which content the messages should have), or how the wireless devices should interpret other signals from the wireless network (e.g., how frame formats should be decoded, how scheduling information should be decoded). It could also include changing the behavior regarding how the wireless device part communicates with the rest of the connected device, or how the wireless device interacts with the human operator(s). It should be noted that examples of behavior changes listed above should not be seen as limiting, as various other behavior changes are possible.

System information in the context of the invention may be any information that is broadcasted by the network (e.g., by a base station, transmission point, an eNodeB, a gNodeB, or any 6G Radio access network element and/or network function) for the UEs'operations and procedures in sleeping mode (such as IDLE, INACTIVE) or in connected mode. Examples of these are the information defined in 3GPP TS 38.331 and included in the Master Information Block (MIB), System Information Blocks (SIBs) such as SIB1, SIB2 and other SIBs, though the techniques described herein are not limited to these examples. The wireless device can receive the broadcast information from a single transmission point or from multiple transmission points and on one or more frequency bands. The broadcast information can be associated with the cell or transmission point or frequency that the wireless device is currently connected to or camping on, or it could be associated with multiple cells or transmission points or frequency layers.

As noted above, the terms wireless terminal, wireless device and/or user equipment (UE) are used interchangeably and can be considered as synonyms for the purpose of this document.

According to the techniques described herein, the UE's behavior, upon receiving at least some broadcasted system information, is made programmable, meaning that, unlike today, the behavior with respect to this system information is not hardcoded in specifications or implemented in the factory. Instead, at least a portion of the broadcasted system information is interpreted by a software program (which may also be called a software function) that is obtained by the wireless device, e.g., from the wireless network, which triggers actions based on this interpretation of the system information by invoking an application program interface (API) or APIs to the operating system for the wireless device, and/or by invoking specific APIs and/or Hayes AT commands/AT responses and/or MT control/MT status commands directed to modem software/hardware in the device. The software program/function may be considered as working at a level of, for example, a mobile termination (MT) or Terminal Adaptor (TA)), etc. In the remainder of this document, the generic term API is used to refer to any predetermined mechanism of interacting between the software program/function provided by the network, as described above, and other components of the wireless device, such as the operating system, TA, MT, etc.

The interpretation of system information by the software program or function can include:
translating the received data bits in the system information to different formats, e.g., Boolean, integer, bitmaps, floating point numbers.
using the received data in raw or interpretated form for evaluating logical conditions, e.g., for evaluating whether a target cell's measured pilot signal exceeds a threshold value in dBm signaled in the system information, to trigger cell re-selection.
using the received data as direct instructions, or rules or policy to control device behavior.

Examples of functionalities that can be offered by the APIs (and in turn examples of what the software function can do) include mechanisms to send message over the radio interface, mechanisms to re-tune radio software or hardware to different frequencies or physical cells, mechanisms to influence the user interface of the wireless devices, mechanisms to initiate communication with some server or other device, etc.

The software program (or software function) may consist of or comprise, in various embodiments, compiled code (e.g., ARM or x86 instructions), platform independent bytecode (e.g., Java byte code, WebAssembly code), or some scripting language (e.g., Javascript, JSON). The software program/function may also or instead comprise a set of rules or parameters configured by the network, for controlling triggers or thresholds for a set of pre-defined events that should be executed by the wireless devices if the conditions for the triggers or thresholds are met. Any of these examples may be referred to as a network-reconfigurable software function, for the purposes of this document.

FIG. 2 is a signaling flow diagram illustrating an example technique for obtaining and using a network-reconfigurable software function. As shown at 210, the flow in this example includes information for obtaining the software function, sent from the network to the UE. As discussed below, this information may not be needed in every instance, or may be obtained from sources other than the wireless network. As shown at block 220, the UE obtains the software function, e.g., by downloading it from an address included in the information sent at signaling step 210.

Subsequently, according to the example shown in the figure, the network transmits broadcasted system information for receipt by the UE, as shown at 230. As shown at block 240, the UE obtains, i.e., receives and decodes, at least part of the broadcasted system information using the software function. The UE then performs one or more actions according to the system information that was obtained, e.g., by being received and decoded, according to the software function, as shown at block 250.

Multiple options are possible for how the wireless device obtains the software function. One option is that the wireless device downloads the software function using its connection to the wireless network. Another option is that the wireless device receives the software function on a separate media, or via a wired connection. It is also possible that the wireless device received the software using a different wireless network, e.g., via Wifi, Bluetooth, a legacy cellular network, or sidelink communication. It is also possible that the wireless device dynamically updates the software function using any of these methods when a new version of the software function is available. The software function might be digitally signed by the any one or more of the device's manufacturer, network vendor, operator or some other trusted entity to ensure that the wireless device does not run untrusted software. In another option, the wireless device accesses a digital version of its protocol stack in a cloud, e.g., from a repository that contains a set of software functions that may be downloaded by the wireless device.

In some embodiments, a wireless device's obtaining of the software function may be preceded by the wireless device receiving information regarding the obtaining of the software function. This information might be, for example, a network address indicated by a network node, where the address indicates a server location of the software function to be downloaded by the UE. Similarly, the information might include a reference indicated by a network node pointing to another network node from which to acquire the software function. For example, the reference might indicate that the wireless device should use sidelink/PC5 to obtain the software from another UE that already has acquired the software function. Thus, in various embodiments the received information may include address information indicating where the software function is located, where the address information may comprise, for example:
one or more Internet Protocol (IP) address(es), or URLs;
one or more Domain Name Server indications;
one or more network node identifiers such as a Radio Access Network (RAN node) identifier (e.g., gNodeB ID) and/or a Core Network node identifier (e.g., Tracking Area Code); and/or
a service identifier (e.g., indicating some control plane function or service in the network).

Alternatively, this information might be a reference indicated by a network node, where the refence refers to a specific function or software component that the wireless device or UE either has obtained earlier, e.g., via a software or firmware update, or that has been pre-configured by the wireless device or UE manufacturer.

Any of these and other instances of this information may be received by the wireless device or UE in a message from the network. In some embodiments, the message may be an RRC message or a Non-Access Stratum message, broadcasted or received in dedicated signaling or via a data radio bearer.

In various embodiments, the wireless device or UE may obtain the software function while in CONNECTED mode, or while in IDLE mode or INACTIVE mode. In some embodiments, the wireless device or UE obtains the software function in dedicated signaling, via RRC or NAS protocol. In some embodiments, the wireless device or UE obtains the software function in a paging message. In some embodiments, the wireless device or UE obtains the software function in a SIM card (Subscriber Identity Module) or eSIM module.

In some embodiments, in the event the wireless network has some specific communication channels for the programmed broadcasted system information, optional indicators may be included in the broadcasted system information, informing the wireless device of which of such communication channels are to be used for sending the information. These communication channels could be in the form of specific radio bearers, such as specific Signaling Radio Bearers (SRBs) or data radio bearers (DRBs). In this case, it is assumed that (e.g., by standard) a certain software program related to a certain broadcasted system information is associated to e.g., SRB X. In this case, the broadcasted system information could include an indicator indicating that this information is associated to SRB X, so that the wireless device can associate the received information to the right communication channel and consequently to the right software program/function.

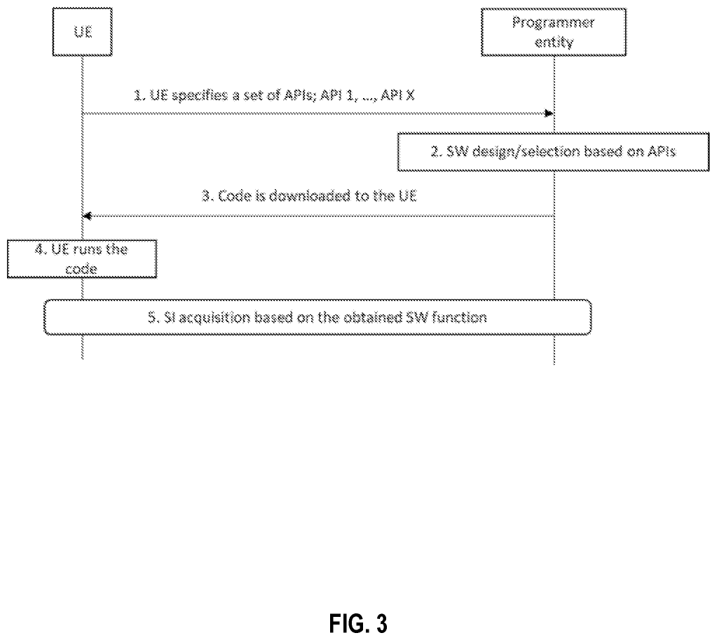

In another set of embodiments, the wireless device or UE exposes one or more Application Programming Interface(s) (API(s)) to the network (e.g., a programming entity at the network) and/or information enabling the network to identify which capabilities the wireless device or UE has, where the one or more APIs are implemented at the wireless device or UE and may be called by a software function that the wireless device or UE downloads from the network and where the wireless device or UE obtains system information based on the software function. An example of this approach is shown in FIG. 3.

In the illustrated example, the UE (or UE designer/manufacturer), at step 1, specifies a set of APIs, which are made available to a programmer entity. At step 2, a software function is designed and/or selected, based on these APIs. As shown at step 3, code for the software function is downloaded to the UE, after which the UE can run the code, as shown at step 4. Then, as shown at step 5, the UE can acquire and interpret system information transmitted by the network in accordance with the software function.

In some embodiments, the wireless device or UE may send assistance information regarding the APIs currently used by the software function provided by the wireless device or UE. For any of various reasons, e.g., low battery, overheat, etc., the wireless device or UE may not want one or more of its APIs to be used in the software function any longer, or for a certain period of time. After receiving the assistance information, the network may modify or remove the software function utilizing that API(s). In another option, the wireless device or UE may indicate to the network that one or more APIs that was locked before (not exposed to the network) is now available to be used in programming, whereby the programmer entity can then modify an existing software function or install a new software function.

As discussed above, in connection with FIG. 2, the UE may, in some instances or embodiments, receive information about the software function, prior to obtaining the software function itself. In some embodiments, the UE may obtain this information in a first system information block (e.g., in a field, parameter and/or information element), where this information indicates that the UE shall obtain the software function, which is subsequently used to obtain further system information.

In some embodiments, the UE determines to obtain the software function (based on which the UE obtains and interprets certain broadcasted system information) upon performing cell selection, e.g., at initial access and/or upon leaving CONNECTED state/mode and/or upon entering IDLE state/mode and/or entering INACTIVE state/mode and/or entering a state optimized for power savings. The reasoning is that upon selecting a cell to camp on, the UE may need to perform actions in IDLE state/mode.

In some of these embodiments, for example, the UE determines whether to obtain and/or to use a software function (based on which the UE obtains broadcasted system information) upon performing cell re-selection. Upon reading the same information in the new cell the UE is re-selecting to, the UE determines to keep running an earlier-obtained software function and/or to stop running an earlier-obtained software function based on an indication in the newly selected cell. For example, if the cell includes a certain indication, the UE continues use of the software function, otherwise it stops using (or deletes) the software function. When the UE reselects to the previous cell, use of the previously obtained software function may be triggered again.

In some embodiments or instances, the UE may receive an indication from the network that an updated version of an already installed software function is available. In one option, the UE receives and installs the updated software function. In another option, the UE indicates its preference regarding its willingness to update the function, and the network decides to keep the current (old) version or to update the software function. In another option, the UE indicates to the network that it does not want to install the new version, and the network either allows the old version to continue running or removes the old version of the software function.

In some embodiments, the UE stores the software function for reading/obtaining a broadcasted system information in such a way that the software function is associated to the cell the UE is connected to and/or is camping on when it obtains the software function.

In some embodiments or instances, the UE deletes the software function and/or stops running the software functions upon entering CONNECTED mode (e.g., in the cell where the software function was obtained). The logic here is that the software is for IDLE and/or INACTIVE procedures and/or reading system information related to IDLE/INACTIVE procedures. Then, upon entering IDLE or INACTIVE mode the UE re-starts the software function.

In some embodiments or instances, the UE stores the software function for reading/obtaining a broadcasted system information for an amount of time controlled by a timer (which may be configured by the network and/or hard coded and/or having its value obtained with the software function and/or obtained via system information). In these embodiments, upon obtaining the software function and/or storing the software function, the UE starts a timer and when the timer expires the UE performs at least one of the following actions:
UE deletes the software function;
UE stops to run the software function;
UE re-obtains the software function, so the software function is overridden (so the UE may possibly obtain an updated version).

In some embodiments or instances, the UE receives an indication (e.g., via a paging message) indicating that a particular software version needs to be obtained. In some embodiments, if a version of the software is already obtained, the UE obtains a new version and overrides the previous version.

In some embodiments, the UE obtains the software function but refrains from executing/running the software function, until execution is triggered by receipt of an indication from the network for executing the obtained software function, or upon the occurrence of a pre-determined condition or set of conditions.

In some embodiments or instances, the UE indicates to the network the outcome of running the code and/or whether the installation was successful or not.

Optionally, a wireless device or UE could, if it discovers that a software or software version that the wireless device does not have is needed for receiving system information, trigger the wireless device to download that software or latest software version.

In addition to information about which software should be used, it is also possible to transmit additional identifiers in the broadcast system information further defining conditions for how the broadcasted data should be handled and/or obtained and/or when the UE shall run/execute the obtained software function. For example, it would be possible to provide information indicating that only certain devices or device types or devices with certain UE capabilities should send data included in the broadcasted system information to the software program(s), or that this data should only be sent if some other conditions are fulfilled such as that the device has other data to transmit, or has just reselected to a new cell, or that the device has low battery consumption, or that the wireless device is allowed to use or be registered to a certain slice type.

In addition, the software program or function that is associated with the broadcast system information can exploit APIs to interact with other components of the wireless device, e.g., with the operating system (OS) to convey information that is intended to that specific OS. For example, a particular wireless device operating system might include support for handling information regarding a pandemic, such as density of the patients in a geographical area, in which the broadcast system information can be used to cause the software program/function to convey that information to the OS, in those devices. Another example is information that data connectivity should be turned off, e.g., because there is an emergency situation and the wireless network should be prioritized and used only by first responders. In this case the OS might allow a user to use e.g., voice calls for emergency purposes but not data connectivity for mobile apps, etc.

In some embodiments or instances, the information broadcasted (to be read/obtained/decoded by the UE, using the software function) may be encrypted and/or signed by the operator, network vendor or other trusted entity to ensure that only valid information is processed by the software function. The encryption or signing can be done using a symmetric (pre-shared) or asymmetric (Private/Public) key. The security mechanism described above could either be part of the specification (standard), in which case information needed to decrypt and/or verify the signature is provided to the UE as information separate from the data to be used by the program, or the security mechanism can be handled by the software program, in which case the data will always be sent to the program and the program itself has ways to verify the data. There are pros and cons with both of these approaches:
Using the specifications would have the benefit of using the same mechanism for all programs and also makes it possible to verify (test) that devices intended for the market support the security features correctly.
Using the software program itself to verify the security is potentially more future proof, since it makes it possible to add new security mechanisms in the future by just updating the software program.

Note that broadcasted system information, such as information carried in SIBs in 3GPP, is not used only for connection purposes. For example, initial information for positioning purposes is also provided in specific SIBs. For beyond 5G, a variety of use cases are envisioned for enabling a rich set of applications. If required, defining and standardizing contents of each application-specific SIB will take a long time. A programmable SIB, which is enabled by the techniques described herein, also enables fast realization of such applications. Hence, in another option the network provides a service for third-party entities to be able to broadcast information for the client part of their applications hosted on the UEs.

In one option, this service could be provided by the network through the application function (AF) mechanism. The AF, as standardized by 3GPP, interacts with the 3GPP core network and, for example, can influence traffic routing. Through this, a trusted application can request to broadcast certain SIBs for its specific purposes.

In addition, broadcasted system information can be delivered to specific applications hosted on the OS, by way of the software functions described herein. In this case, an identifier(s) can be assigned to the system information indicating which specific application(s) the SI targets. In this case it should further be possible to indicate that the flexible SI block should only be decoded and interpreted if the OS hosts certain applications. An example would be to convey broadcast information to industrial UEs, e.g., to provide information related to industrial devices who operate in autonomous mode (e.g., autonomous guided vehicle). The information can include spatial or mapping information, information about routes etc.

The handling of broadcasted system information by the software function can take any of several forms. In various embodiments, for instance, the UE may receive and process system information, using the software function, by:
reading and/or interpreting all or parts of the content of one or more System Information Blocks (SIBs) by running the software function; and/or
obtaining a first system information (e.g., based on implementation of the specifications) that comprises scheduling information (e.g., in time and frequency domain) indicating where to obtain second system information, and based on the scheduling information obtaining the second system information, and finally decoding the second system information based on the software function. This approach enables the network to send software specific system information separate from other system information that the software can obtain and interpret.
obtaining a first system information (e.g., based on implementation of the specifications) using scheduling information (e.g., in time and frequency domain) that is processed and interpreted using the software function.
obtaining a new System Information Block (SIB) and/or a new information Element and/or parameter within a specified SIB, transmitted by the network within a message. In this case, the software function, when executed, enables the UE to read/decode/obtain the new SIB message (and/or field and/or parameter and/or IE), apply its content/configuration and act accordingly, i.e., performing the actions associated to the feature configured by the new SIB.

In some embodiments the UE obtains a SIB according to its implementation and according to specified functions, as specified in the standards. However, upon receiving an indication to do so, e.g., using standardized techniques, application-specific triggers, or by receiving and interpreting other broadcast system information using the software function, the UE runs the software function to interpret the SIB, which may contain one or more information fields specified by the standards as well as other information, not defined by the standards but interpretable by the software function. This case is an example of how the standardized method for delivering system information (e.g., the way SIBs are scheduled) may be used in combination with a programmability framework to enable new information to be broadcasted and to enable the UE to perform action upon such a broadcasted information.

In some embodiments or instances, the UE obtains an indication indicating that the UE needs to run/execute the software function. This means that the UE reads the system information based on the software functions at a moment that is not immediately upon reception of the software function but is instead triggered by another indication received from the network after the obtaining of the software function.

In some embodiments, for example, the UE obtains a first indication (e.g., a field and/or parameter within a first SIB) indicating that certain second system information is to be interpreted by a software function. In order for the wireless device/UE to know that certain information provided on the system broadcast channel is to be obtained/decoded/interpreted/read and/or that should be handled by the software program (a software function), the network could include one or more indicators on the broadcast channel (e.g., in a first SIB message) indicating which other elements, information elements, parameters, fields or data should be handled by one or more software programs. These indicators can be specified in standards specifications, e.g., by a standardization organization and thus supported by the wireless devices supporting the specifications or standard. Multiple ways for coding the indicators, that tell that certain information or data should be handled by the program, can be considered. For example:
Use one or more separated System Information Blocks for transmitting the information. E.g., the standard could specify that SIB X should be handled by the software program. All information in SIB X will then be sent to the software program to be interpreted further by the program. A variant of this is that the standard could define a split Y for SIB numbers, where e.g., a generic SIB X is standards-defined (thus processed directly by the wireless device) if X<=Y whereas it should be provided to the software program if X>Y (of course, instead of split numbers it could be different ranges).
Use special information elements (IEs) for the information. The information elements could be defined as a generic Octet or bit stream, and the IE format could indicate the size of the information element so that the wireless device knows exactly which bits should be sent to the program.
Use a default routing for unknown System Information Blocks. The standard has specified a certain number of System Information Blocks (e.g., for NR Rel. 15, 3GPP specified from System Information Block 1 up to System Information Block 9), then the wireless device knows that any System Information Block X with X different from e.g., 1, 2, . . . , 9 has to be handled by the software program.
Use a specific “programmed System Information Block” indicator. The standard could specify an indicator to explicitly indicate whether the received System Information Block is a programmed System Information Block (and thus to be handled by the software program). This indicator could be e.g., in the form of a single bit, where “0” might mean that the received System Information Block is a legacy (standardized) System Information Block that the wireless device can thus natively handle whereas “1” might mean that received System Information Block is a programmed (non-standardized) System Information Block and, since the wireless device doesn't know how to handle it, the received System Information Block should be directed towards the software program.
Use a specific broadcast channel. By introducing a new logical channel, a UE configured with the software function would monitor this broadcast channel and any System Information message received on this broadcast channel are forwarded to the software function. Any System Information message received on the legacy broadcast channel are handled using standardized legacy procedures. A UE which is not configured with the software function, does not monitor the new broadcast channel and thus ignores any message transmitted on this channel.
In another embodiment, the software function handles all SIBs, both the legacy and modified. If the software function receives a legacy SIB, it executes the actions as specified, or it forwards the SIB to the legacy function in the UE, whereas the modified SIBs are executed by the software function. In another embodiment, the software function executes both the legacy SIBs and the new SIBs.

The techniques described above are backwards compatible since legacy UEs, i.e., UEs not equipped with the software function, can ignore any SIBs, IEs, and/or indicators that they are not able to decode.

In another example, the network node effectively overwrites or replaces an existing SIB with the programmable System Information Blocks (SIBs). In this case, only devices configured with the software program to decode the SIBs are able to interpret these SIBs or, in some cases, to even connect to the network. This approach could be used, for instance, in a confined area (e.g., a factory) operating at frequency bands not associated with legacy specifications, e.g., above 100 GHz. In an example implementation according to this approach, the software function applies a new definition of an existing SIB, (e.g., SIB1), where the new definition contains a different set of information elements (IEs), e.g., adding, removing, reordering, or re-defining IEs. A UE configured with the software function will interpret the redefined SIB by using the software function, whereas legacy UEs (or UEs without the software function) will incorrectly decode the SIB, which may mean that they are unable to access the network.

In some embodiments, in the event that multiple software programs/functions are utilized in the network, it would be possible to include optional indicators (e.g., in the broadcasted system information) informing the wireless devices of which program should interpret which broadcasted information. This might take the form of explicit indicators indicating that each of one or more certain software functions should handle one or more respective elements in the broadcasted system information. Alternatively, there may be an implicit, pre-determined, one-to-one mapping between software function and system information to be read/obtained/interpreted, for example, and/or one software function could be used to read/obtain/interpret multiple broadcasted system, information, like multiple SIBs. Example cases of using multiple programs could be that there are different programs used by different wireless devices or that multiple programs are running in parallel in the same or overlapping groups of wireless devices. Any of the indicators described herein could include information such as software program name, and/or some numerical identifier and/or software version.

In various embodiments, the software function the UE obtains, when executed, enables the UE to read and/or decode and/or obtain and/or acquire system information, apply its content/configuration and act accordingly, i.e., perform the actions associated to the feature configured by the system information. The actions may be performed according to API(s) accessed by the software function and/or obtained by the UE when the software function is downloaded.

In some embodiments, the actions according to the received broadcasted system information are communication-related actions performed while the UE is in a mode of operation optimized for power saving, such as RRC_IDLE or RRC_INACTIVE. For example, any one or more of the following communication-related actions might be influenced and optimized by the obtained software functions:
UE-controlled mobility based on network configuration, and/or the manner in which the UE performs measurements for cell selection and/or cell reselection;
Monitoring of Short Messages transmitted with P-RNTI over DCI;
Monitoring of a Paging channel for CN paging using 5G-S-TMSI;
Performing neighboring cell measurements and cell (re-)selection;
Acquisition of system information and possible transmissions of SI requests by the UE (if configured);
Logging of available measurements together with location and time for logged measurements, for configured UEs;
Handling of the UE Inactive Access Stratum (AS) context;

Handling of RAN-based notification area configured by RRC layer;
RAN-based notification area updates periodically and when moving outside the configured RAN-based notification area;
Performing of idle/inactive measurements for idle/inactive measurement configured UEs;
Performing a random access procedure to access a network for UL/DL data or signaling.

To be sure, the operation of most or all of these examples is currently specified by network standards. With the software functions described herein, however, this standardized operation can be adjusted or overridden, e.g., for a specific group or class of wireless devices, to optimize the operation for a specific use case, a specific network, etc.

In some embodiments or instances, the actions performed according to the received broadcasted system information as interpreted by the software function(s) are communication-related actions performed while the UE transitions from RRC_IDLE or RRC_INACTIVE to RRC_CONNECTED.

In some embodiments or instances, the actions performed according to the received broadcasted system information as interpreted by the software function(s) are actions the UE performs only once i.e., one shot actions, such as reading some specific information and providing the information to higher layers in the UE's protocol stack, such as the application layer.

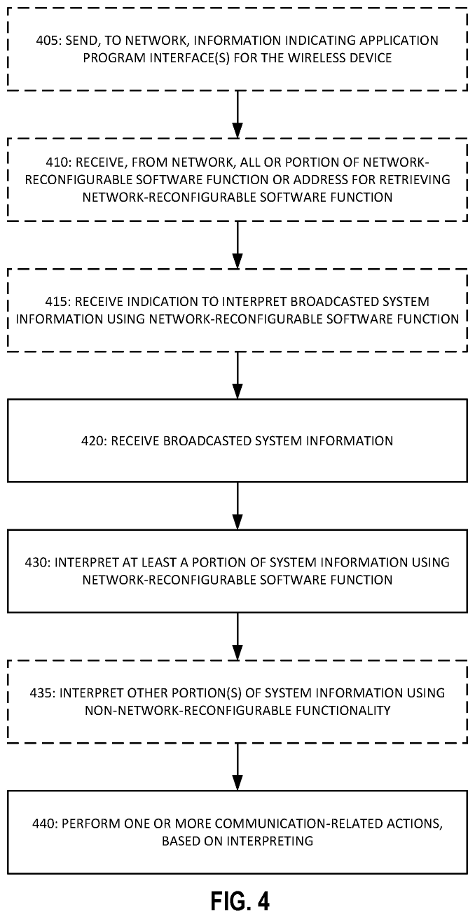

In view of the details provided above, it will be appreciated that FIG. 4 illustrates an example method, implemented in a wireless device operating in a wireless network, for receiving and acting upon broadcasted system information using a network-configurable software function like those described above. The method shown in FIG. 4 is intended to be a generalization of and encompass many of the techniques described above. Thus, where the specific terminology used here to describe FIG. 4 differs somewhat from corresponding terminology used above, the former should be understood as at least encompassing the latter, unless the context clearly indicates otherwise.

As shown at block 420, the method comprises the step of receiving system information broadcasted by the wireless network. The system information may, for example, be broadcasted by one or more network nodes in the wireless network. This corresponds to, for example, the signaling shown at step 230 in FIG. 2.

The method illustrated in FIG. 4 further comprises the step of interpreting at least a first portion of the received system information using a network-reconfigurable software function in the wireless device, as shown at step 430. Further, as shown at step 440, the method comprises performing one or more communication-related actions, based on this interpreting. Several examples of these communication-related actions were described above.

In some embodiments or instances, the system information may include, in addition to the portion of the system information that is interpreted using the network-reconfigurable software function, one, several, or many fields that are intended to be interpreted in accordance with standardized specifications for the network. Thus, the method may comprise the step of interpreting one or more other portions of the received system information that are standardized by industry standards. The one or more other portions of the system information may be interpreted using non-network-reconfigurable functionality in the wireless device. Note that the term “non-network-reconfigurable functionality” as used herein refers to functionality other than, i.e., distinct from, the network-reconfigurable software function defined above. In the present context, this non-network-reconfigurable functionality comprises software, firmware, and/or digital logic configured to interpret and act upon standardized elements of system information in accordance with industry standards. This is shown at block 435, which is illustrated with a dashed outline to indicate that it might not appear in every instance or embodiment of the method otherwise illustrated in the figure.

In some embodiments, the first portion of the system information comprises one or more information elements in a system information block (SIB), e.g., as defined by 3GPP. In some of these embodiments, this SIB is a SIB specifically designated by industry standards to carry information for interpretation by network-reconfigurable software functions in wireless devices. The SIB may also carry the one or more other portions of system information, in addition to the first portion of the system information. In some embodiments, one or more information elements in the SIB may be information elements having corresponding definitions in industry standards for the wireless network, but where these information elements are interpreted by the network-reconfigurable software function using a respective definition differing from the corresponding definition in the industry standards. For example, each of at least one of the one or more information elements may have a corresponding definition in industry standards for the wireless network, but each of the at least one of the one or more information elements may be interpreted by the wireless device using a respective definition differing from the corresponding definition in the industry standards. In other words, one or more standardized information elements may be effectively redefined by the network-reconfigurable software function.

In some embodiments or instances, the interpreting and performing steps shown in blocks 430 and 440 are in response to receiving an indication to carry out said interpreting and performing. Receiving this indication is shown at block 415.

In some embodiments or instances, the receiving, interpreting, and performing steps shown in blocks 420-440 are preceded by receiving, from the wireless network, data comprising at least a portion of the network-reconfigurable software function. This is shown at block 410. Alternatively, the steps shown at blocks 420-440 might be preceded by receiving, from the wireless network, address information indicating where program data for the network-reconfigurable software function is retrievable, and retrieving the program data according to the address information. This is also shown at block 410. In either case, in some instances or embodiments the method may further comprise, upon receiving data comprising at least a portion of the network-reconfigurable software function from the wireless network or from a network address provided by the wireless network, starting a timer, where the remaining steps of the illustrated method are conditioned on the timer not having expired.

As discussed above, the network-reconfigurable software function might in some instances be generated or selected according to capabilities of the UE. As shown at block 405, the method may, in some embodiments or instances, comprise the step of sending, to the wireless network, information indicating application device interfaces (APIs) available in the wireless device for network-reconfigurable software functionality.

Any of the variations described above may be applied to the method shown in FIG. 4. The method, and variants thereof, might be implemented by a UE operating in a 3GPP-defined wireless communication network, or by some other wireless device.

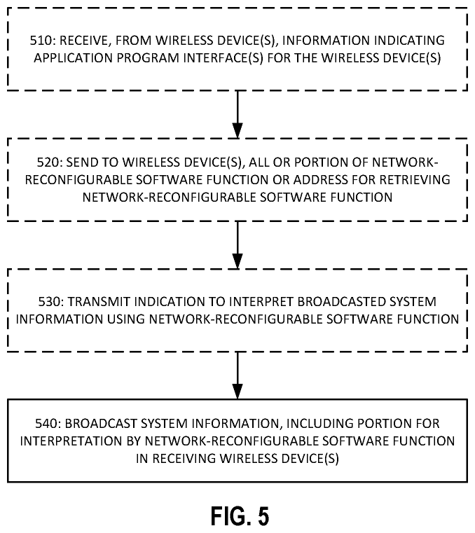

FIG. 5 illustrates an example method as might be carried out in one or more network nodes of a wireless network, such as in a base station. The method comprises, as shown at block 540, the step of broadcasting system information, the system information including a first portion for interpretation by a network-reconfigurable software function executed by one or more receiving wireless devices.

As discussed above, this first portion of the system information may comprise one or more information elements in a SIB. The SIB may be a SIB specifically designated by industry standards to carry information for interpretation by the network-reconfigurable software function in wireless devices. Whether or not the SIB is a re-purposed or extended pre-existing SIB or a SIB specifically designated by industry standards to carry information for interpretation by the network-reconfigurable software function in wireless devices, the SIB might also carry one or more other portions of system information that are standardized by industry standards. In some embodiments or instances, one or more information elements in the SIB may be information elements having corresponding definitions in industry standards for the wireless network, where the interpreting by the receiving wireless device comprises interpreting at least one of the one or more information elements using a respective definition differing from the corresponding definition in the industry standards. For example, each of at least one of the one or more information elements may have a corresponding definition in industry standards for the wireless network, but the interpretation of each of the at least one of the one or more information elements may be done by a network-reconfigurable software function using a respective definition differing from the corresponding definition in the industry standards.

In some embodiments, the method may comprise the step of transmitting, to one or more of the receiving wireless devices, an indication to interpret the first portion using the network-reconfigurable software function. This is shown at block 530. Further, in some embodiments or instances, the method may comprise, prior to the step of broadcasting, sending data comprising at least a portion of the network-reconfigurable software function to the one or more of the receiving wireless devices. This is shown at block 520. Alternatively or additionally, the method may comprise sending address information indicating where program data for the network-reconfigurable software function is retrievable to the one or more of the receiving wireless devices. This is also shown at block 520.

In some embodiments, the method may comprise receiving, from at least one of the one or more of the receiving wireless devices, information indicating application device interfaces (APIs) available in the wireless device for network-reconfigurable software functionality. This is shown at block 510. This information may be used to generate or select the software function to be provided to the wireless device, in some embodiments.

Any of the variations described above may be applied to the method shown in FIG. 5. The method, and variants thereof, might be implemented by a base station or network node operating in a 3GPP-defined wireless communication network, or by some other node or combination of nodes. At least some of the functionality described in connection with this method might be implemented in a virtual environment, as described in further detail below.

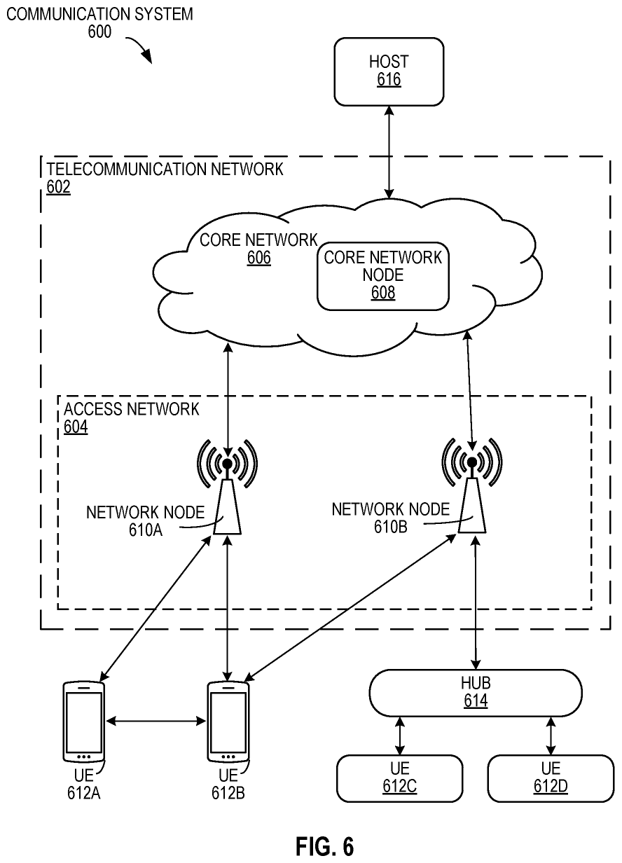

FIG. 6 shows an example of a wireless communication system 600 in which the techniques described herein may be implemented, in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3rd Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC), ZigBee, Light Fidelity (LiFi), and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

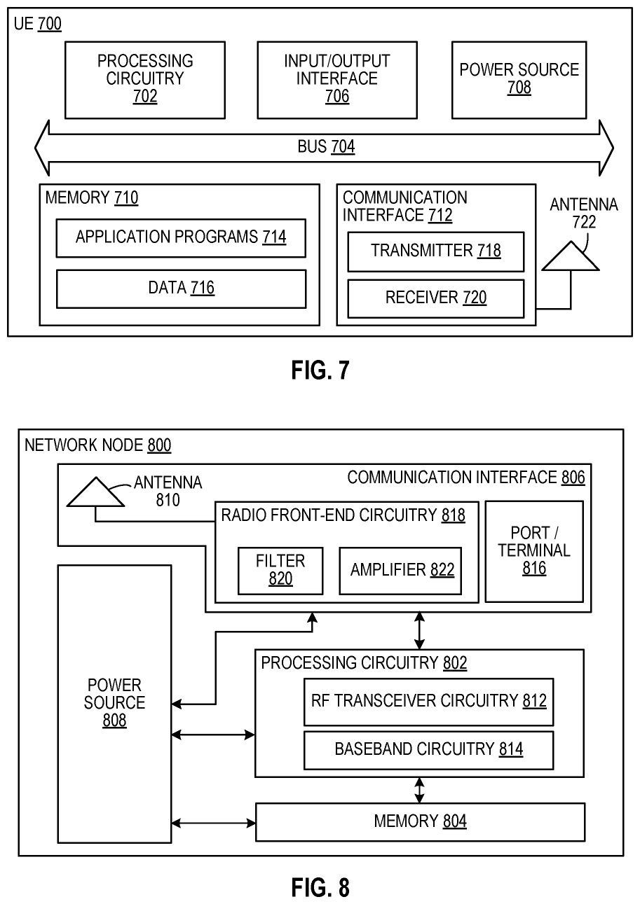

FIG. 7 shows a UE 700 in accordance with some embodiments. This UE 700 may be regarded as an example of the wireless devices described herein and may be configured to carry out any of the various techniques described above in connection with wireless devices, e.g., using the processing circuitry 702 and communication interface circuitry 712 described in detail below. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments, which may be configured to carry out all or parts of the network-related functionality described above. As used herein, the term network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide network node 800 functionality, either alone or in conjunction with other network node 800 components, such as the memory 804.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between the network node 800 and any of another network node, e.g., another radio access network node or a core network node, or one or more UEs. As illustrated, the communication interface 806 comprises port(s)/terminal(s) 816 to send and receive data, for example to and from another network node over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

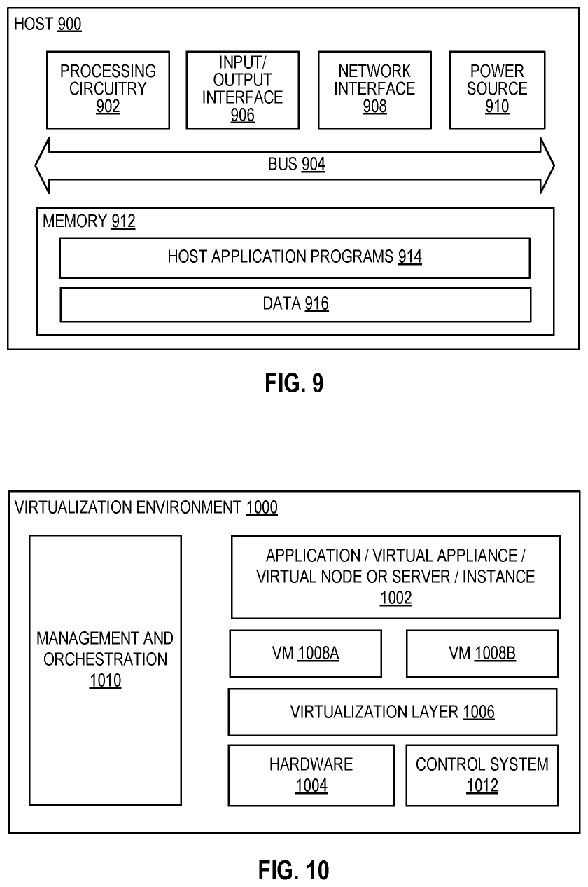

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs. In some embodiments or instances, the host may utilize the network-reconfigurable software functions described above to carry out a specific use case.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments of the techniques described herein may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

The solutions described herein enable the introduction of new features in the air interface and/or core network of a 6G system (and/or 5G evolution system), for the UEs and the network, without requiring standardization that is specific for the operation of that particular feature. This increases the lifetime of the UEs on the market, reducing the need to invest in new HW, saving money and leading to reduced environmental impact, as well as reducing the dependency from having software/firmware upgrade functionalities offered by UE vendors. The solution can be particularly beneficial for industrial Internet of Things, or Integrated Transport (e.g., Vehicle to X) scenarios where it is expected that the wireless device will be deployed for longer lifetimes (e.g., the lifetime of an industrial robot, or vehicle) than typically seen in mobile broadband scenarios using smartphones.

The features discussed above can be operator-specific and/or use-case-specific (and thus also UE-specific or specific to a group of UEs), which makes it possible to tailor the system to specific use cases, which may not be used outside specific markets and thus are not seen as important enough to require standardization updates and updates to the wireless devices. For example, assume that there is a use case for 5G in the mining industry requiring certain alarms to be sent to the people working in the mine e.g., when there is blasting, gas leaks, etc. It might be desirable to use triggers on the system information broadcast channel, to trigger the devices to setup a group call session due to these alarms. Assuming this feature is only used for mining use cases, it is unlikely it would be standardized today and supported in modem chipsets since the market for the feature is relatively small.

Another advantage arising from the use of these techniques is that they make it possible for a network operator to introduce operator-specific features, increasing the innovation in the market and adding value to an operator system over their competitors. For example, assume an operator offers a service for cheaper use of the system by end users during times of low network load, or when users are in lightly loaded cells. In this case, the operator could program the devices of their users, via indications transmitted by broadcasted system information that is interpreted according to the network-reconfigurable software functions described above to upload or download background data only when the devices obtain some specific system information broadcasted in the cell indicating that the system is lightly loaded. Alternatively, the indications of light loading might be made visible to the users, via the software functions described herein so that, in some embodiments, the users could then program their devices to download/or upload data only when network indicates in system information that the system is lightly loaded or that special charging rules applies.

As another example, assume an operator offers a data service that is only available in a certain location and/or for certain users, either due to business reasons or due to that the access to the data is local to a specific site, e.g., office building, stadium, campus. With the techniques described herein it is possible for the network to instruct UEs to connect to this local data service, by providing the devices with a specific software function and broadcasting the availability of the local data service, which is interpreted by the software function, without the need to specify this functionality in the standards, meaning it can be applied for existing devices on the market.

Another advantage of the techniques described herein is that they make it possible to support secure delivery of data over system broadcast channels, thus protecting end user privacy and/or operator information from competitors. As an example, a network operator might wish to share load or overload information with its connected devices, in order to optimize traffic steering between different frequency layers or different radio access technologies (RATs). If such a solution were to be standardized, it would be possible for competing operators to monitor the load in the operator's network, thus gaining market insights, etc. With the flexible programmability provided by the presently disclosed techniques, however, it is possible for the operator to obfuscate and/or encrypt the load information so that information is meaningless for anybody just monitoring the information on the broadcast channel. At the same time, UEs with the correct programming can act on the broadcast information as interpreted by the network-reconfigurable software function.

1. A method for handling system information, performed by a wireless device operating in a wireless network, the method comprising:
receiving system information broadcasted by one or more network nodes in the wireless network;
interpreting a first portion of the system information using a network-reconfigurable software function in the wireless device; and
performing one or more communication-related actions, based on said interpreting.

2. The method of claim 1, wherein the method further comprises interpreting, using non-network-reconfigurable functionality in the wireless device, one or more other portions of the system information that are standardized by industry standards.

3. The method of claim 1, wherein the first portion of the system information comprises one or more information elements in a system information block, SIB.

4. The method of claim 3, wherein the SIB is a SIB designated by industry standards to carry information for interpretation by network-reconfigurable software functions in wireless devices.

5. The method of claim 3, wherein the method further comprises interpreting, using non-network-reconfigurable functionality in the wireless device, one or more other portions of the system information that are standardized by industry standards, wherein the SIB also carries the one or more other portions of the system information.

6. The method of claim 3, wherein each of at least one of the one or more information elements has a corresponding definition in industry standards for the wireless network, and wherein said interpreting comprises interpreting each of the at least one of the one or more information elements using a respective definition differing from the corresponding definition in the industry standards.

7. The method of claim 1, wherein said interpreting and performing are in response to receiving an indication to carry out said interpreting and performing.

8. The method of claim 1, wherein said receiving, interpreting, and performing are preceded by receiving, from the wireless network, data comprising at least a portion of the network-reconfigurable software function.

9. The method of claim 1, wherein said receiving, interpreting, and performing are preceded by receiving, from the wireless network, address information indicating where program data for the network-reconfigurable software function is retrievable, and retrieving the program data according to the address information.

10. The method of claim 8, wherein the method comprises sending, to the wireless network, information indicating application device interfaces, APIs, available in the wireless device for network-reconfigurable software functionality.

11. The method of claim 8, wherein the method comprises, upon receiving data comprising at least a portion of the network-reconfigurable software function from the wireless network or from a network address provided by the wireless network, starting a timer, wherein said interpreting and performing is conditioned on the timer not having expired.

12. A method for handling system information, performed by one or more network nodes of a wireless network, the method comprising:
broadcasting system information, the system information including a first portion for interpretation by a network-reconfigurable software function executed by one or more receiving wireless devices.

13-16. (canceled)

17. The method of claim 12, wherein the method comprises transmitting, to the one or more receiving wireless devices, an indication to interpret the first portion using the network-reconfigurable software function.

18. The method of claim 12, wherein the method comprises, prior to said broadcasting, sending, to the one or more receiving wireless devices, data comprising at least a portion of the network-reconfigurable software function.

19. The method of claim 12, wherein the method comprises, prior to said broadcasting, sending, to the one or more receiving wireless devices, address information indicating where program data for the network-reconfigurable software function is retrievable.

20. The method of claim 18, wherein the method comprises receiving, from at least one of the one or more receiving wireless devices, information indicating application device interfaces, APIs, available in the wireless device for network-reconfigurable software functionality.

21. (canceled)

22. A wireless device, comprising:
communication interface circuitry; and
processing circuitry operatively associated with the communication interface circuitry, wherein the processing circuitry is configured to:
receive system information broadcasted by one or more network nodes in the wireless network;
interpret a first portion of the system information using a network-reconfigurable software function in the wireless device; and
perform one or more communication-related actions, based on said interpreting.

23. The wireless device of claim 22, wherein the processing circuitry (702) is configured to interpret, using non-network-reconfigurable functionality in the wireless device, one or more other portions of the system information that are standardized by industry standards.

24-26. (canceled)

27. A network node, comprising:
communications interface circuitry configured for communicating with one or more other network nodes and with one or more wireless devices; and
processing circuitry operatively associated with the communications interface circuitry, wherein the processing circuitry is configured to broadcast system information, the system information including a first portion for interpretation by a network-reconfigurable software function executed by one or more receiving wireless devices.

28. The network node of claim 27, wherein the processing circuitry is configured to transmit, to the one or more receiving wireless devices, an indication to interpret the first portion using the network-reconfigurable software function.

29-30. (canceled)
